(19) United States
(12) Patent Application Publication
(10) Pub. No.: US 2022/0274875 A1
(43) Pub. Date: Sep. 1, 2022

(54) ARTIFICIAL STONE

(71) Applicant: LX Hausys, Ltd., Jung-gu Seoul (KR)

(72) Inventors: Hongkwan CHO, Gangseo-gu Seoul (KR); Hye Won KIM, Gangseo-Gu Seoul (KR)

(73) Assignee: LX Hausys, Ltd., Jung-gu Seoul (KR)

(21) Appl. No.: 17/627,982

(22) PCT Filed: Jul. 20, 2020
(86) PCT No.: PCT/KR2020/009540

§ 371 Date: Jan. 18, 2022

(30) Foreign Application Priority Data
Jul. 19, 2019 (KR) 10-2019-0087396
Jul. 20, 2020 (KR) 10-2020-0089529

(51) Int. Cl. C04B 26/16; C04B 14/06; C08G 18/73; C08G 18/32; C08G 18/20

(52) U.S. Cl. CPC C04B 26/16; C04B 14/06; C08G 18/73; C08G 18/3206; C08G 18/2027; C08G 18/2018; C04B 2111/80

(57) ABSTRACT

An artificial stone and a curable composition for manufacturing the artificial stone are provided. The curable composition is capable of manufacturing an artificial stone that has excellent optical properties, is free to show color and the like, has excellent physical properties such as scratch resistance, and also has remarkable light resistance. The curable composition has formability and physical properties that are suitable for being formed into artificial stone.

### TECHNICAL FIELD

The present application relates to artificial stone and a curable composition.

### BACKGROUND ART

Artificial stone, such as artificial marble, is used for various applications, including interior materials or building materials, and the like.

In the industry, the artificial stone is generally classified into MMA series and E stone series. The artificial stone of MMA series refers to artificial stone formed mainly by a casting method using a material that a filler is blended with an acrylic polymer such as PMMA (poly(methyl methacrylate)). Meanwhile, the E stone is an abbreviation of engineered stone, which refers to artificial stone manufactured mainly by a press method using mainly a material that a filler is blended with an unsaturated polyester (UPE) binder resin.

For any type of artificial stone, it is important to ensure transparency and appropriate color. For example, if the artificial stone is opaque or has an unnecessary color sense, an intended effect such as a decorative effect is greatly reduced, or it is also difficult to add a desired color to the artificial stone.

In addition, light resistance is required for the artificial stone. The artificial stone is often used outdoors, where for example, occurrence of yellowing or the like should be prevented when exposed to ultraviolet rays.

In order to solve this problem, conventionally, a method of blending in the artificial stone a sunscreen such as titanium dioxide, an ultraviolet absorber or a radical stabilizer, and the like has been used. However, the titanium dioxide or the like blended in the artificial stone makes the artificial stone opaque due to its own unique color, and also makes it difficult to control the color of the artificial stone.

As another method, a method of manufacturing artificial stone using epoxidized linseed oil, referred to as a so-called bio resin, is also known. However, due to the unique yellow color of the used binder, a large amount of white pigment must be applied to the above method, and it is difficult to control the color of the artificial stone.

### DISCLOSURE

### Technical Problem

The present application is intended to provide a curable composition having formability and physical properties that are suitable for molding artificial stone and capable of manufacturing artificial stone that has excellent optical properties, is free to give color and the like, has excellent physical properties such as scratch resistance, and also has remarkable light resistance, and artificial stone made of such a curable composition.

### Technical Solution

Physical properties mentioned in the present application are those measured at room temperature unless otherwise specified. The term room temperature is a natural temperature without cooling and warming, which may mean, for example, any temperature within the range of about 10° C. to 30° C., any temperature within the range of 20° C. to 30° C., or a temperature 23° C. or 25° C. as a low temperature.

The present application provides a curable composition. The curable composition may be a so-called thermosetting composition. That is, the curable composition may be cured by application of heat.

The curable composition may be used for various applications. In one example, the curable composition may have formability and physical properties suitable for manufacturing artificial stone such as artificial marble. Therefore, the curable composition may be a curable composition for artificial stone. The artificial stone made of the curable composition has excellent optical properties such as transparency and color, is free to give color and the like, has excellent physical properties such as scratch resistance, and also has remarkable light resistance.

The curable composition may comprise a polyol component and an isocyanate component, and may also comprise a filler together with the foregoing.

The term polyol component means a component which consists of one polyol or is a mixture of two or more polyols, and the term isocyanate component means a component which consists of one isocyanate compound or is a mixture of two or more isocyanate compounds. That is, when one polyol in the curable composition is present, the polyol component is the one polyol, and when two or more polyols are present, the polyol component is the mixture of the two or more polyols. In addition, when one isocyanate compound in the curable composition is present, the isocyanate component is the one isocyanate compound, and when two or more isocyanate compounds are present, the isocyanate component is the mixture of the two or more isocyanate compounds.

The polyol component and the isocyanate component may form a so-called polyurethane through curing reaction. Therefore, the component of the curable composition including the polyol component and the isocyanate component and excluding the filler may also be referred to as a polyurethane binder component.

Therefore, in the curable composition for forming the artificial stone, the component excluding the filler, which includes the polyol component and the isocyanate component, may also be referred to as a binder component.

The polyol component may include so-called bifunctional polyol (which may also be referred to as a glycol) and multifunctional polyol. Here, the bifunctional polyol means a compound having two hydroxyl groups (OH), and the multifunctional polyol means a compound having trifunctionality or more, that is, three or more hydroxyl groups (OH). The multifunctional polyol may have, for example, trifunctionality to decafunctionality. In one example, the multifunctional polyol may have nonafunctionality or less, octafunctionality or less, heptafunctionality or less, hexafunctionality or less, pentafunctionality or less, or tetrafunctionality or less. In one example, the multifunctional polyol may be a trifunctional polyol.

Through the application of the two polyols, the curable composition may have formability suitable for manufacturing artificial stone and impart a high curing density to the artificial stone after curing to increase the strength and surface hardness of the artificial stone. In addition, the use of the two polyols also contributes to improvement of light resistance and weather resistance.

The type of the polyol applicable in the present application is not particularly limited. For example, as the bifunctional polyol, an aliphatic polyol (glycol) having 1 to 20 carbon atoms, 1 to 16 carbon atoms, 1 to 12 carbon atoms, 1 to 8 carbon atoms, or 1 to 4 carbon atoms, such as ethylene glycol, diethylene glycol, triethylene glycol, pentaethylene glycol, polyethylene glycol, tetraethylene glycol, 1,6-hexanediol, 1,5-pentanediol, 1,4-pentanediol, 1,3-pentanediol, 1,2-pentanediol, 1,2-butanediol, 1,3-butanediol, 1,4-butanediol, 1,7-heptanediol, 1,6-heptanediol, 2,3-heptanediol, 1,4-heptanediol, 1,2-heptanediol, 1,3-heptanediol or 3,5-heptanediol, may be used.

As the multifunctional polyol, trimethylolpropane, trimethylolpropane ethoxylate, trimethylolmethane, trimethylolethane, trimethylolpropane monoallyl ether, trimethylolhexane, triethylolpropane, 1,2,4-butanetriol, glycerol, pentaerythritol, dipentaerythritol or trimethylolphosphine, and the like may be used.

In order to secure appropriate physical properties, a component comprising 80 mol % or more of a polyol having a molecular weight of 500 g/mol or less (hereinafter, may be referred to as a low molecular weight polyol) may be used as the polyol component.

In another example, the molecular weight of the low molecular weight polyol may be 480 g/mol or less, 460 g/mol or less, 440 g/mol or less, 420 g/mol or less, 400 g/mol or less, 380 g/mol or less, 360 g/mol or less, 340 g/mol or less, 320 g/mol or less, 300 g/mol or less, 280 g/mol or less, 260 g/mol or less, 240 g/mol or less, 220 g/mol or less, 200 g/mol or less, 180 g/mol or less, 160 g/mol or less, or 140 g/mol or less, or may be 50 g/mol or more, 52 g/mol or more, 54 g/mol or more, 56 g/mol or more, 58 g/mol or more, 60 g/mol or more, 72 g/mol or more, 74 g/mol or more, 76 g/mol or more, 78 g/mol or more, 80 g/mol or more, 82 g/mol or more, 84 g/mol or more, 86 g/mol or more, 88 g/mol or more, 90 g/mol or more, 92 g/mol or more, 94 g/mol or more, 96 g/mol or more, 98 g/mol or more, 100 g/mol or more, 110 g/mol or more, 120 g/mol or more, or 130 g/mol or more or so.

In one example, the content of the low molecular weight polyol in the polyol component may be 82 mol % or more, 84 mol % or more, 86 mol % or more, 88 mol % or more, 90 mol % or more, 92 mol % or more, 94 mol % or more, 96 mol % or more, or 98 mol % or more, and the content may be 100 mol % or less.

In order to secure appropriate physical properties, a component comprising 80 mol % or more of a non-aromatic polyol may be used as the polyol component. The non-aromatic polyol may be a polyol which is not aromatic, and in one example, the non-aromatic polyol may be a non-aromatic acyclic polyol.

In one example, the content of the non-aromatic polyol in the polyol component may be 82 mol % or more, 84 mol % or more, 86 mol % or more, 88 mol % or more, 90 mol % or more, 92 mol % or more, 94 mol % or more, 96 mol % or more, or 98 mol % or more, and the content may be 100 mol % or less.

Meanwhile, the polyol component may comprise the bifunctional polyol in a ratio of 25 to 55 mol %. In another example, the ratio may be 27 mol % or more, 29 mol % or more, 31 mol % or more, 33 mol % or more, 35 mol % or more, 37 mol % or more, or 39 mol % or more, or may also be 53 mol % or less, 51 mol % or less, 49 mol % or less, 47 mol % or less, 45 mol % or less, 43 mol % or less, or 41 mol % or less or so.

In the polyol component of the curable composition, the ratio (P2/PM) of the mole number (P2) of the bifunctional polyol to the mole number (PM) of the multifunctional polyol (P2/PM) may be in a range of 0.2 to 1.5. In another example, the ratio may be 0.25 or more, 0.3 or more, 0.35 or more, 0.4 or more, 0.45 or more, 0.5 or more, 0.55 or more, 0.6 or more, or 0.65 or more, or may also be 1.4 or less, 1.3 or less, 1.2 or less, 1.1 or less, 1.0 or less, 0.95 or less, 0.9 or less, 0.85 or less, 0.8 or less, 0.75 or less, or 0.7 or less or so.

As the polyol forming the polyol component, various known polyols may be applied, as described above, but the polyol component applied so that the non-aromatic polyols having the above molecular weight satisfy the above ratio may be combined with an isocyanate component which is described below to further maximize the desired effect herein.

In the present application, as the isocyanate component, a component comprising a bifunctional isocyanate compound and a multifunctional isocyanate compound having trifunctionality or more may be used.

The term bifunctional isocyanate compound means a compound having two isocyanate groups, and the multifunctional isocyanate compound means a compound having trifunctionality or more, that is, three or more isocyanate groups. The multifunctional isocyanate compound may have, for example, trifunctionality to decafunctionality. In one example, the multifunctional isocyanate compound may have nonafunctionality or less, octafunctionality or less, heptafunctionality or less, hexafunctionality or less, pentafunctionality or less, or tetrafunctionality or less. In one example, the multifunctional isocyanate compound may be a trifunctional isocyanate compound.

Through the application of the two isocyanate compounds, the curable composition may have formability suitable for manufacturing artificial stone and impart a high curing density to the artificial stone after curing to increase the strength and surface hardness of the artificial stone. In addition, the use of the two isocyanate compounds also contributes to improvement of light resistance and weather resistance.

The type of the isocyanate compound applicable in the present application is not particularly limited. For example, as the bifunctional isocyanate compound, isophorone diisocyanate (IPDI), 2,2,4-trimethylhexane-1,6-diisocyanate (TMDI) or 4,4′-methylenedicyclohexyl diisocyanate (H12-MDI), and the like, or a hydrogenated aromatic diisocyanate may be used. The aromatic diisocyanate may be exemplified by xylene diisocyanate, diphenylmethane diisocyanate, tetramethylxylene diisocyanate, methylenediphenyl diisocyanate or naphthalene diisocyanate, and the like, but is not limited thereto.

In one example, as such a bifunctional isocyanate compound, a compound as represented by the following formula 1 may be used.

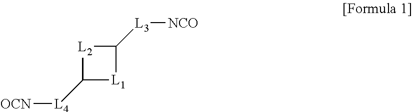

In Formula 1, L₁ to L₄ are each independently a single bond or an alkylene group having 1 to 20 carbon atoms.

In Formula 1, L₁ and L₂ are each independently a single bond or an alkylene group, but at least one may be an alkylene group. In this case, when only one of L₁ and L₂ is an alkylene group, the carbon number of the alkylene group may be in a range of 1 to 20, 2 to 20, 3 to 20, 3 to 16, 3 to 12, or 3 to 8. In addition, when both L₁ and L₂ are alkylene groups, the total number of carbon atoms in the alkylene groups may be in the range of 1 to 20, 2 to 20, 3 to 20, 3 to 16, 3 to 12, or 3 to 8.

In one example, any one of L₁ and L₂ may be an alkylene group having 1 to 2 carbon atoms, and the other may be an alkylene group having 3 to 20 carbon atoms, 3 to 16, 3 to 12, 3 to 8, or 3 to 4 carbon atoms.

Meanwhile, in Formula 1, L₃ and L₄ may be each independently a single bond or an alkylene group having 1 to 20 carbon atoms, 1 to 16 carbon atoms, 1 to 12 carbon atoms, 1 to 8 carbon atoms, or 1 to 4 carbon atoms.

The alkylene group of Formula 1 may be linear or branched, and may also be optionally substituted with one or more substituents other than an isocyanate group.

In addition, as the multifunctional isocyanate compound, hexamethylene diisocyanate isocyanurate (HDI isocyanurate), hexamethylene diisocyanate imino oxadiazine dione (HDI-imino oxadiazine dione), a hexamethylene diisocyanate biuret trimer (HDI biuret trimer), a hexamethylene diisocyanate trimer (HDI trimer), hexamethylene diisocyanate biuret (HDI biuret), hexamethylene diisocyanate uretdione (HDI uretdione), or a trimer blended by hexamethylene diisocyanate (HDI) and/or isophorone diisocyanate (IPDI)), and the like may be used, without being limited thereto.

These ingredients are variously known in the art. For example, as the hexamethylene diisocyanate trimer (HDI trimer), a compound known as Asahi Kasei's Duranate TUL-100, Duranate TLA-100, Duranate TKA-100, Duranate TSA-100 or Duranate TSE-100, or Covestro's Desmodur N3300, Desmodur N3900 or Desmodur N3600, and the like may be used; as the hexamethylene diisocyanate biuret (HDI biuret), a compound known as Asahi Kasei's Duranate 24A-100 or Covestro's Desmodur N100 or Desmodur N3200, and the like may be used; as the hexamethylene diisocyanate uretdione (HDI uretdione), a compound known as Covestro's Desmodur N3400 or Desmodur XP2840, and the like may be used; and as the trimer blended by hexamethylene diisocyanate (HDI) and isophorone diisocyanate (IPDI), a compound known as Covestro's Desmodur XP2838, and the like may be used.

In order to secure appropriate physical properties, a component comprising 80 mol % or more of an isocyanate compound having a molecular weight of 1000 g/mol or less (hereinafter, may be referred to as a low molecular weight isocyanate compound) may be used as the isocyanate compound component.

In another example, the molecular weight of the low molecular weight isocyanate compound may be 950 g/mol or less, 900 g/mol or less, 850 g/mol or less, 800 g/mol or less, 750 g/mol or less, 700 g/mol or less, 650 g/mol or less, 600 g/mol or less, 550 g/mol or less, 500 g/mol or less, 450 g/mol or less, 400 g/mol or less, 350 g/mol or less, 300 g/mol or less, 250 g/mol or less, or 200 g/mol or less, or may be 50 g/mol or more, 100 g/mol or more, 150 g/mol or more, 200 g/mol or more, 250 g/mol or more, 300 g/mol or more, 350 g/mol or more, 400 g/mol or more, or 450 g/mol or more or so.

In one example, the content of the low molecular weight isocyanate compound in the isocyanate compound component may be 82 mol % or more, 84 mol % or more, 86 mol % or more, 88 mol % or more, 90 mol % or more, 92 mol % or more, 94 mol % or more, 96 mol % or more, or 98 mol % or more, and the content may be 100 mol % or less.

In order to secure appropriate physical properties, a component comprising 80 mol % or more of a non-aromatic isocyanate compound may be used as the isocyanate compound component. The non-aromatic isocyanate compound is an isocyanate compound that is not aromatic. For example, when the non-aromatic isocyanate compound is applied as the bifunctional isocyanate compound, a non-aromatic cyclic compound (so-called alicyclic compound) may be used as the isocyanate compound, and in this case, the compound may be a compound of Formula 1 above. Furthermore, when the multifunctional isocyanate compound is a non-aromatic isocyanate compound, the compound may be cyclic or acyclic.

In one example, the content of the non-aromatic isocyanate compound in the isocyanate compound component may be 82 mol % or more, 84 mol % or more, 86 mol % or more, 88 mol % or more, 90 mol % or more, 92 mol % or more, 94 mol % or more, 96 mol % or more, or 98 mol % or more, and the content may be 100 mol % or less.

The isocyanate compound component may comprise the bifunctional isocyanate compound in a ratio of 55 to 90 mol %. In another example, the ratio may be 57 mol % or more, 59 mol % or more, 61 mol % or more, 63 mol % or more, 65 mol % or more, 67 mol % or more, 69 mol % or more, or 71 mol % or more, or may also be 88 mol % or less, 86 mol % or less, 84 mol % or less, 82 mol % or less, 80 mol % or less, 78 mol % or less, 76 mol % or less, 74 mol % or less, 72 mol % or less, or 70 mol % or less or so.

The ratio (P2/PM) of the mole number (N2) of the bifunctional isocyanate compound to the mole number (NM) of the multifunctional isocyanate compound in the isocyanate compound component of the curable composition may be in a range of 1.5 to 5. In another example, the ratio may be 1.7 or more, 1.9 or more, 2.1 or more, 2.3 or more, or 2.5 or more, or may also be 4.8 or less, 4.6 or less, 4.4 or less, 4.2 or less, 4.0 or less, 3.8 or less, 3.6 or less, 3.4 or less, 3.2 or less, 3.0 or less, 2.8 or less, 2.6 or less, 2.4 or less, 2.2 or less, or 2.0 or less or so.

As the isocyanate compound forming the isocyanate compound component, various known isocyanate compounds may be applied, as described above, but the isocyanate compound component applied so that the non-aromatic isocyanate compounds having the above molecular weight satisfy the above ratio may be combined with the polyol component to further maximize the desired effect herein.

Although the blending ratio between the polyol component and the isocyanate component in the curable composition of the present application is not particularly limited, for example, the ratio (P/N) of the mole number (P) of the polyol compound in the polyol component to the mole number (N) of the isocyanate compound in the isocyanate component may be adjusted to be within a range of 0.4 to 1.5. In another example, the ratio (P/N) may be 0.45 or more, 0.5 or more, 0.55 or more, 0.6 or more, 0.65 or more, 0.7 or more, 0.75 or more, 0.8 or more, or 0.85 or more, or may also be 1.4 or less, 1.3 or less, 1.2 or less, 1.1 or less, 1.0 or less, 0.95 or less, 0.9 or less, 0.85 or less, or 0.8 or less or so.

In another example, the polyol and isocyanate components may be blended in the curable composition so that the ratio (OH/NCO) of the mole number of the total hydroxyl groups (OH) in the polyol component to the mole number (NCO) of the total isocyanate groups in the isocyanate component is in a range of 0.5 to 1.5. In another example, the ratio (OH/NCO) may be 0.55 or more, 0.6 or more, 0.65 or more, 0.7 or more, 0.75 or more, 0.8 or more, 0.85 or more, or 0.9 or more, or may also be 1.4 or less, 1.3 or less, 1.2 or less, 1.1 or less, 1.0 or less, 0.95 or less or so.

In another example, the binder component may comprise 20 to 60 parts by weight of the polyol component relative to 100 parts by weight of the isocyanate component. The term part by weight is a weight ratio between components. Specifically, the ratio of the polyol component may be 22 parts by weight or more, 24 parts by weight or more, 26 parts by weight or more, 28 parts by weight or more, 30 parts by weight or more, 32 parts by weight or more, or 34 parts by weight or more, or may also be 58 parts by weight or less, 56 parts by weight or less, 54 parts by weight or less, 52 parts by weight or less, 50 parts by weight or less, 48 parts by weight or less, 46 parts by weight or less, 45 parts by weight or less, 44 parts by weight or less, 42 parts by weight or less, 40 parts by weight or less, 38 parts by weight or less, or 36 parts by weight or less or so, relative to 100 parts by weight of the isocyanate component.

In such a range, it is possible to provide a curable composition capable of forming artificial stone, which prevents yellowing due to ultraviolet rays or the like, by exhibiting excellent formability and workability before curing, and having excellent transparency and color characteristics after curing and having excellent light resistance.

The curable composition of the present application may comprise a filler together with the above components. As the applicable filler, a known filler, for example, a known filler being applied to the manufacture of artificial stone may be applied without any particular limitation.

For example, a so-called quartz-based filler or a filler such as aluminum hydroxide may be applied as the filler.

In one example, a mixture of fillers including so-called quartz sand and quartz powder may be applied as the quartz-based filler.

The terms quartz sand and quartz powder are types of quartz-based fillers classified according to the particle size.

For example, the term quartz sand means a quartz-based filler having a particle size of approximately 0.01 mm to 2 mm or so. In another example, the particle size of the quartz sand may be 0.02 mm or more, 0.03 mm or more, 0.04 mm or more, 0.05 mm or more, or 0.06 mm or more. In addition, the particle size of the quartz sand may be 1.9 mm or less, 1.8 mm or less, 1.7 mm or less, 1.6 mm or less, 1.5 mm or less, 1.4 mm or less, 1.3 mm or less, 1.2 mm or less, 1.1 mm or less, 1.0 mm or less, 0.9 mm or less, 0.8 mm or less, 0.7 mm or less, 0.6 mm or less, 0.5 mm or less, 0.4 mm or less, or 0.3 mm or less. In one example, as the quartz sand, a mixture of quartz sand having a particle size of 0.3 mm or less or less than 0.3 mm within the above-described range and quartz sand having a particle size of 0.3 mm or more or more than 0.3 mm within the above-described range may be used.

Meanwhile, the term quartz powder means a quartz-based filler having a particle size of 250 to 400 mesh. In this case, it means a quartz-based filler passing through a sieve with a particle size of 250 to 400 mesh. For example, the size of the quartz powder may be 270 mesh to 380 mesh, 290 mesh to 360 mesh, 310 mesh to 340 mesh, or 320 mesh to 330 mesh. The mesh means a hole number included in a 1-inch sieve, which may be expressed in a unit representing the size of solid particles.

A method of measuring the particle size of the quartz-based filler is not particularly limited. The particle size of the filler can be measured by applying a known method for measuring the particle size for artificial stone, where the method is a method of measuring the size of the particles using a sieve having a defined mesh size.

By applying the quartz-based filler so as to have the particle size distribution as above, it is possible to exhibit a level of an esthetic sense similar to that of natural stone along with physical properties such as excellent scratch resistance.

In one example, the quartz powder may be used in a ratio of 25 to 60 parts by weight relative to 100 parts by weight of the quartz sand. In another example, the ratio of the quartz powder may be 30 parts by weight or more, 35 parts by weight or more, 40 parts by weight or more, or 45 parts by weight or more, or may also be 57 parts by weight or less, 54 parts by weight or less, 51 parts by weight or less, or 49 parts by weight or less.

Also, in one example, the weight ratio of the quartz sand based on the total weight of the filler may be 50 to 90 wt % or so. In another example, the ratio may be 52 wt % or more, 54 wt % or more, 56 wt % or more, 58 wt % or more, 60 wt % or more, 62 wt % or more, 64 wt % or more, or 66 wt % or more, or may also be 85 wt % or less, 80 wt % or less, 75 wt % or less, or 70 wt % or less or so.

In addition, when a mixture of quartz sand having a particle size of 0.3 mm or less or less than 0.3 mm (hereinafter, small quartz sand) and quartz sand having a particle size of 0.3 mm or more or more than 0.3 mm (hereinafter, large quartz sand) is applied as the quartz sand, the large quartz sand may be used in a ratio of 25 to 60 parts by weight relative to 100 parts by weight of the small quartz sand. In another example, the ratio of the above large quartz sand may be 30 parts by weight or more, 35 parts by weight or more, 40 parts by weight or more, or 45 parts by weight or more, or may also be 57 parts by weight or less, 54 parts by weight or less, 51 parts by weight or less, or 49 parts by weight or less.

The curable composition may comprise the filler component in a ratio of 70 to 95 wt % based on the total weight of the curable composition. In another example, the ratio may be 72 wt % or more, 74 wt % or more, 76 wt % or more, 78 wt % or more, 80 wt % or more, 82 wt % or more, 84 wt % or more, 86 wt % or more, or 88 wt % or more, or may also be 93 wt % or less or 91 wt % or less or so.

The total weight part of the polyol component and the isocyanate component in the curable composition may be in a range of 5 to 30 parts by weight relative to 100 parts by weight of the filler.

In another example, the total weight part (weight part of the binder component) of the polyol component and the isocyanate component may also be 7 parts by weight or more, 9 parts by weight or more, 11 parts by weight or more, or 12 parts by weight or more, or may be 28 parts by weight or less, 26 parts by weight or less, 24 parts by weight or less, 22 parts by weight or less, 20 parts by weight or less, 18 parts by weight or less, 16 parts by weight or less, 14 parts by weight or less, or 13 parts by weight or less, relative to 100 parts by weight of the filler.

Through such a ratio, it is possible to provide a curable composition that more efficiently satisfies the desired properties.

The curable composition may comprise necessary additional components along with the above components. For example, the curable composition may further comprise a catalyst for curing the polyol component and the isocyanate component. As the catalyst, a known catalyst (e.g., a urethane reaction catalyst) may be used without particular limitation. For example, a so-called tertiary amine may be used as the catalyst.

The ratio of the catalyst is not particularly limited, which may be used in a catalytic amount. For example, the catalyst may be included in an amount of 1 part by weight or less relative to 100 parts by weight of the isocyanate component. The catalyst may be included in an amount of 0.8 parts by weight or less, 0.6 parts by weight or less, 0.4 parts by weight or less, 0.2 parts by weight or less, or 0 parts by weight relative to 100 parts by weight of the isocyanate component. The catalyst may be included within the above-described range to accelerate a curing reaction time. For example, the curing reaction may be completed within 1 hour at 120° C. In addition, under the content of the catalyst, it is possible to secure a time capable of controlling the shape of the curable composition to a desired shape before the start of the curing reaction, and it is possible to maintain excellent optical properties and color senses of the cured product.

In one example, as the catalyst, a catalyst containing no metal may be used. That is, as the catalyst, a metal catalyst or an organo-metal hybrid catalyst may not be used, whereby problems such as generation of bubbles due to overcuring may be solved.

The tertiary amine is a compound in the form that three hydrogen atoms of ammonia are substituted with hydrocarbon groups, and one or more compounds selected from the group consisting of imidazole, N,N-dimethylaminopyridine, N-methylmorpholine, triethanolamine, N-cocomorpholine 2,2′-dimorpholinyldiethyl ether, N,N′-bis-[3-(dimethylamino)propyl]urea, N,N-dimethylcyclohexylamine and 2,4,6-tris(dimethylaminomethyl)phenol may be used, but the types of applicable catalysts are not limited thereto.

In addition to the foregoing, the curable composition may freely comprise various known necessary components.

The curable composition may be prepared by appropriately mixing the above-described components, and for example, the curable composition may be prepared by first blending an isocyanate component and a polyol component as a binder component, and then blending them with a filler component.

The present application also relates to artificial stone, such as artificial marble. The artificial stone may be manufactured by curing the above-described curable composition. Therefore, the artificial stone may be a cured product of the curable composition.

A method for manufacturing artificial stone by curing a curable composition is not particularly limited, and usually a method for manufacturing artificial stone, for example, a method of curing using a casting process or curing using a press process may be applied. The curable composition of the present application exhibits formability and curability suitable for manufacturing artificial stone as described above.

In addition, the artificial stone formed by the curable composition can exhibit texture equivalent to that of natural stone, or the like, has excellent optical properties, can freely implement a desired color as necessary, and also has excellent various mechanical properties.

For example, the artificial stone may have a flexural strength according to KS F 4739 in a range of 30 MPa to 80 MPa. The flexural strength means the maximum stress until the cured product breaks due to a bending load. Specifically, the flexural strength of the cured product may be in the range of 40 MPa to 75 MPa, or 50 MPa to 70 MPa.

The artificial stone may have a compressive strength according to KS F 2519 in a range of 170 MPa to 300 MPa. The compressive strength means the maximum stress until the cured product breaks when subjected to compressive force. Specifically, the compressive strength of the cured product may be in the range of 200 MPa to 240 MPa or 210 MPa to 230 MPa.

The binder component (i.e., the component of the curable composition comprising the polyol component and the isocyanate component, and excluding the filler) applied to the artificial stone may be cured to exhibit excellent optical transparency. For example, the cured product of the binder component may exhibit transmittance of 90% or more. In another example, the transmittance may be 90.5% or more, or 91% or more, or may be 95% or less, 94% or less, 93% or less, or 92% or less or so. The transmittance is transmittance measured using a D65 standard light source, and is transmittance measured in the thickness direction for the artificial stone having a thickness of 5 mm.

In addition, the artificial stone may exhibit excellent color characteristics, and for example, the value of L* in CIE Lab color coordinates may be 90 or more. The L* may be a value related to the initial color of the artificial stone immediately after manufacturing. The CIE Lab color coordinates are color values prescribed by the International Commission on Illumination, where the L* in the color coordinates is a numerical value indicating brightness. The lower limit of L* is 0, the upper limit is 100, and 0 means black, and the larger the L* value, it means a color closer to white or the color of the light source. In another example, the L* value may be 90.5 or more, or 91 or more, or may be 98 or less, 95 or less, or 93 or less or so.

In the present application, L*, a* and b* values in CIE Lab color coordinates are values measured using a known CIE LAB colorimeter. That is, the L*, a* and b* values are values measured using a light source mounted on a CIE LAB colorimeter (Spectro-guide, BYK).

The artificial stone may have a b* value in the CIE Lab in a range of −1.0 to 3.5. The b* value is a numerical value indicating the degree of yellow and blue of the artificial stone; as the value increases, it means that the object exhibits a color closer to yellow; and conversely, as the value decreases, it means that the object exhibits a color closer to blue.

In another example, the b* value in the initial state may be 3.3 or less, or 3.0 or less, or may be −0.7 or more, 0.4 or more, or 0 or more.

The artificial stone may exhibit excellent light resistance, particularly resistance to ultraviolet rays.

For example, in the artificial stone, the change amount ΔE of the color change index may be maintained below a certain level even after being exposed to ultraviolet rays having a wavelength of about 340 nm at an intensity of 0.6 W/m² for 1000 hours. For example, in the artificial stone, the absolute value of the change amount ΔE of the color change index before and after being exposed to ultraviolet rays having a wavelength of about 340 nm at an intensity of 0.6 W/m² for 1000 hours may be 3 or less.

The change amount ΔE of the color change index can be measured by Equation 1 below.

ΔE=(ΔL*²+Δa*²+Δb*²)^{1/2} [Equation 1]

In Equation 1, ΔL*, Δa* and Δb* are values determined by Equations 2 to 4 below, respectively.

ΔL*=La*−Li* [Equation 2]

In Equation 2, La* is the L* value of the artificial stone in the CIE Lab color coordinates immediately after being exposed to ultraviolet rays having a wavelength of about 340 nm at an intensity of 0.6 W/m² for 1000 hours, and Li* is the L* value of the artificial stone in the CIE Lab color coordinates immediately before exposure to the ultraviolet rays.

Δa*=aa*−ai* [Equation 3]

In Equation 3, aa* is the a* value of the artificial stone in the CIE Lab color coordinates immediately after being exposed to ultraviolet rays having a wavelength of about 340 nm at an intensity of 0.6 W/m² for 1000 hours, and ai* is the a* value of the artificial stone in the CIE Lab color coordinates immediately before exposure to the ultraviolet rays.

Δb*=ba*−bi* [Equation 4]

In Equation 2, ba* is the b* value of the artificial stone in the CIE Lab color coordinates immediately after being exposed to ultraviolet rays having a wavelength of about 340 nm at an intensity of 0.6 W/m² for 1000 hours, and bi* is the b* value of the artificial stone in the CIE Lab color coordinates immediately before exposure to the ultraviolet rays.

In Equations 1 to 4, the meanings of L* and b* are the same as described above. In addition, the a* is a physical quantity indicating the degree of red and green, where it means that as the value increases, the object exhibits a color closer to red, and as the value increases, the object exhibits a color closer to green.

In the artificial stone, the Δb* in Equation 4 may be in a range of −1.5 to 3.0 or −1.5 to 1.5. In another example, the Δb* may be −1 or more, or −0.5 or more, or may also be 2.5 or less, or 2 or less or so.

In such a range, the artificial stone may exhibit excellent optical transparency and color senses, and if necessary, the color sense of the pigment added to the artificial stone is expressed, whereby the color adjustment may be freely performed. Here, the values of L*, a* and b* indicating the color of the artificial stone are color characteristics in a state in which no pigment or dye that implements other colors is included other than the above-described binder component and filler component.

The shape of the artificial stone as above is selected according to the purpose, which is not particularly limited, and dimensions such as its thickness are adjusted according to the purpose, which are not limited.

### Advantageous Effects

The present application can provide a curable composition having formability and physical properties that are suitable for molding artificial stone and capable of manufacturing artificial stone that has excellent optical properties, is free to give color and the like, has excellent physical properties such as scratch resistance, and also has remarkable light resistance, and artificial stone made of such a curable composition.

### DESCRIPTION OF DRAWINGS

FIGS. 1 and 2 are images of artificial stone manufactured with the curable composition of Example 1 immediately before and immediately after being exposed to ultraviolet rays for 1000 hours, respectively.

FIGS. 3 and 4 are images of artificial stone manufactured with the curable composition of Comparative Example 1 immediately before and immediately after being exposed to ultraviolet rays for 1000 hours, respectively.

FIGS. 5 and 6 are images of artificial stone manufactured with the curable composition of Comparative Example 2 immediately before and immediately after being exposed to ultraviolet rays for 1000 hours, respectively.

### BEST MODE

Hereinafter, the present application will be described in detail through Examples, but the scope of the present application is not limited by Examples below.

1. Formability Evaluation

The curable compositions prepared in Examples or Comparative Examples are each introduced into a mold for artificial stone, and molded into a plate shape by applying compression while vibrating the upper plate of the mold for 1 minute and 30 seconds using a vibrator under a vacuum condition. Subsequently, the molded material was heat-cured with a top and bottom hot-press oven, in which the top and bottom plates were each set at a temperature of 120° C., for 1 hour. After curing is completed, the cured product is cooled to room temperature, taken out from the mold, and then cut in all directions, and surface-polished to manufacture artificial stone. When the artificial stone is stably manufactured through such a process, the formability is evaluated as PASS, and when the artificial stone cannot be manufactured for reasons such as phase separation and high or low viscosity, it is evaluated as NG.

2. Transparency Evaluation

The binders (mixtures of resin components before mixing with a quartz-based filler) prepared in Examples or Comparative Examples are each maintained at a temperature of 120° C. for 1 hour or so and cured, thereby forming a plate-shaped cured product having a thickness of 5 mm or so. Subsequently, using a CM-5 spectrophotometer (Konica minolta) and a D65 standard light source, transmittance (transparency), and b* values of CIE Lab color coordinates of transmitted light are evaluated. The meaning of the b* value is the same as in the text.

3. Evaluation of Scratch Resistance

Scratch resistance was evaluated through the Erichsen test on the plate-shaped cured product formed in the same manner as in the transparency evaluation.

The Erichsen test is a surface strength test performed using Erichsen's scratch hardness tester 413, where it is evaluated as PASS in the case of satisfying a value of 1.4N (the standard value) or more, and it is evaluated as NG in the case of less than 1.4N. In the test method, a specimen is fixed on the tester, and then the weight is increased by 0.1N from 0 using diamond tips and weights, and it is confirmed whether scratches are generated on the surface. The weight at the time when the scratches are visible is weighed.

4. Light Durability Evaluation

The curable compositions of Examples or Comparative Examples are each applied to the method in the above formability evaluation to manufacture artificial stone. Using QUV equipment (QUV, Q-LAB), the manufactured artificial stone has been exposed to ultraviolet rays with a wavelength of 340 nm at an intensity of 0.6 W/m², where the temperature inside the equipment is maintained at 50° C.

Using a CIE LAB colorimeter (Spectro-guide, BYK), L*, a* and b* values of the CIE Lab color space are each measured. The definitions of the L*, a* and b* values are the same as in the text. The L*, a*, and b* values before and after ultraviolet exposure are obtained, respectively, and ΔL*, Δa* and Δb* values are obtained, respectively, through the difference between the values before and after ultraviolet exposure.

Thereafter, the color change value ΔE can be obtained by substituting the obtained values into Equation A below.

ΔE=(ΔL*²+Δa*²+Δb*²)^{1/2} [Formula A]

### Example 1

37 wt % of hydrogenated xylene diisocyanate (Takenate-600, Mitsui Chemical) (molecular weight: about 194.24 g/mol), 36 wt % of an HDI isocyanurate trimer (hexamethylene diisocyanate isocyanurate trimer, Desmodur N3300, Covestro) (molecular weight: about 504.6 g/mol), 17 wt % of trimethylolpropane (molecular weight: about 134.17 g/mol), 9 wt % of diethylene glycol (molecular weight: about 106.12 g/mol) and 1 wt % of a tertiary amine (1-methylimidazole) were mixed at room temperature to prepare a mixture (binder).

As a filler, a quartz-based filler was prepared. The quartz-based filler was prepared by mixing 41 wt % of quartz sand having an average particle size of about 0.1 mm to 0.3 mm, 19 wt % of quartz sand having an average particle size of about 0.3 mm to 0.7 mm, and 29 wt % of quartz powder having an average particle size of about 325 mesh.

A curable composition was prepared by uniformly mixing the binder and the quartz-based filler in a weight ratio of 89:11 (binder: quartz-based filler).

### Example 2

A curable composition was prepared in the same manner as in Example 1, except that isophorone diisocyanate (IPDI) (molecular weight: about 222.3 g/mol) was used instead of hydrogenated xylene diisocyanate when preparing the binder.

### Example 3

A curable composition was prepared in the same manner as in Example 1, except that hexamethylene diisocyanate biuret (HDI biuret) (Covestro's Desmodur N3200) (molecular weight: 478.59 g/mol) was used instead of HDI isocyanurate when preparing the binder.

### Comparative Example 1

A curable composition was prepared in the same manner as in Example 1, except that a general unsaturated polyester for E-stone (engineered stone) was used as the binder.

### Comparative Example 2

A curable composition was prepared in the same manner as in Example 1, except that a bio resin in the form of a mixture, in which 55 wt % of epoxidized linseed oil (Arkema), 41 wt % of a hexahydro-4-methylphthalic anhydride curing agent (Aldrich) and 4 wt % of a polyol solution dissolved by 1-methylimidazole were mixed at room temperature, was used as the binder.

### Comparative Example 3

A curable composition was prepared in the same manner as in Example 1, except that hydrogenated xylene diisocyanate was not used when preparing the binder and the amount of HDI isocyanurate was 74 wt %.

### Comparative Example 4

A curable composition was prepared in the same manner as in Example 1, except that HDI isocyanurate was not used when preparing the binder and the amount of hydrogenated xylene diisocyanate was 74 wt %.

The relationships such as the mole numbers of the bifunctional polyol (diethylene glycol), multifunctional polyol (trimethylolpropane), bifunctional isocyanate compound (hydrogenated xylene diisocyanate, isophorone diisocyanate) and trifunctional isocyanate compound (HDI isocyanurate, HDI biuret) applied in each of Examples 1 to 3 and Comparative Examples 3 to 6 were summarized and described in Table 1 below.

TABLE 1

| | | Example | | | Comparative Example | |
|---|---|---|---|---|---|---|
| | | 1 | 2 | 3 | 3 | 4 |
| Polyol | DEG | 0.08 | 0.08 | 0.08 | 0.08 | 0.08 |
| | TMP | 0.13 | 0.13 | 0.13 | 0.13 | 0.13 |
| NCO | HXDN | 0.19 | 0 | 0.19 | 0 | 0.38 |
| compound | IPDI | 0 | 0.17 | 0 | 0 | 0 |
| | HDII | 0.07 | 0.07 | 0 | 0.14 | 0 |
| | HDIB | 0 | 0 | 0.08 | 0 | 0 |

| | | | | | |
|---|---|---|---|---|---|
| OH/NCO | 0.92 | 1.01 | 0.91 | 1.27 | 0.73 |
| P2/PM | 0.67 | 0.67 | 0.67 | 0.67 | 0.67 |
| N2/NM | 2.67 | 2.33 | 2.53 | 0 | — |
| P/N | 0.81 | 0.89 | 0.8 | 1.46 | 0.56 |

NCO compound: isocyanate compound;
DEG: mole number ratio of diethylene glycol in the binder;
TMP: mole number ratio of trimethylolpropane in the binder;
HXDN: mole number ratio of hydrogenated xylene diisocyanate in the binder;
IPDI: mole number ratio of isophorone diisocyanate in the binder;
HDII: mole number ratio of HDI isocyanurate in the binder;
HDIB: mole number ratio of HDI burette in the binder;
OH/NCO: molar ratio of the total hydroxyl groups in the polyol component to the total isocyanate groups in the NCO compound;
P2/PM: ratio of the mole number of the bifunctional polyol to the mole number of the multifunctional polyol;
N2/NM: ratio of the mole number of the bifunctional NCO compound to the mole number of the multifunctional NCO compound;
P/N: ratio of the mole number of polyol to the mole number of NCO compound

Evaluation results for the curable compositions of Examples and Comparative Examples above were summarized and described in Tables 2 and 3 below. However, in the case of Comparative Examples 3 and 4, the artificial stone was not properly manufactured for the reasons such as phase separation, high viscosity, low viscosity or low hardness, whereby the formability became NG, so that other physical properties could not be evaluated.

TABLE 2

| | Example | | |
|---|---|---|---|
| | 1 | 2 | 3 |
| Formability | PASS | PASS | PASS |
| Transmittance (%) | 91.2 | 90.4 | 89.1 |
| b* of CIE Lab color space | 0.57 | 1.21 | 1.42 |
| Scratch resistance | PASS | PASS | PASS |

TABLE 3

| | Comparative Example | | | |
|---|---|---|---|---|
| | 1 | 2 | 3 | 4 |
| Formability | PASS | PASS | NG | NG |
| Transmittance (%) | 87.9 | 89.8 | — | — |
| b* of CIE Lab color space | −0.05 | 4.5 | — | — |
| Scratch resistance | PASS | PASS | — | — |

Light durability evaluation results for the curable compositions of Examples and Comparative Examples above were summarized and described in Table 4 below. However, in the case of Comparative Examples 3 and 4, the artificial stone was not properly manufactured for the reasons such as phase separation, high viscosity, low viscosity or low hardness, whereby the formability became NG, so that other physical properties could not be evaluated.

TABLE 4

| | | Example | | | Comparative Example | |
|---|---|---|---|---|---|---|
| | | 1 | 2 | 3 | 1 | 2 |
| CIE Lab characteristics | L* | 91.07 | 80.28 | 78.65 | 89.78 | 88.31 |
| immediately before exposure to | a* | 0 | −0.11 | −0.08 | −0.15 | −0.15 |
| ultraviolet rays for 1000 hours | b* | 2.42 | 2.32 | 3.33 | 3.85 | 6.91 |
| CIE Lab characteristics | L* | 91.41 | 80.22 | 80.09 | 88.55 | 92.14 |
| immediately after exposure to | a* | −0.40 | −0.55 | −0.47 | −1.11 | −0.26 |
| ultraviolet rays for 1000 hours | b* | 3.49 | 3.87 | 5.24 | 19.61 | 5.16 |

| | | | | | |
|---|---|---|---|---|---|
| ΔE | 1.19 | 1.61 | 2.42 | 15.84 | 4.21 |
| Δb* | 1.07 | 1.55 | 1.91 | 15.76 | −1.75 |

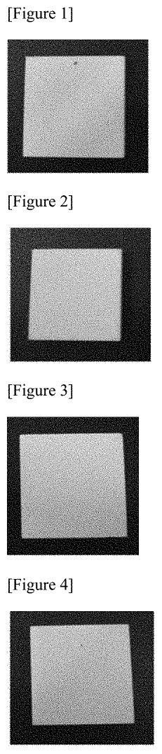

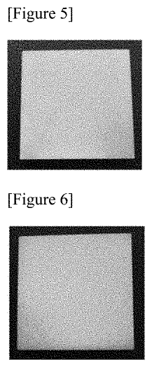

From Table 4, it can be confirmed that the artificial stone manufactured with the curable compositions of Examples in its initial state exhibits the larger L* value compared to Comparative Examples, resulting in the brighter color and simultaneously exhibits the color closer to white through the lower b* value. In addition, it can be confirmed that color change and yellowing are suppressed even after exposure to ultraviolet rays. FIG. 1 is an image of artificial stone manufactured with the curable composition of Example 1 before ultraviolet exposure and FIG. 2 is an image of the artificial stone after exposure to ultraviolet rays for 1000 hours; FIG. 3 is an image of artificial stone manufactured with the curable composition of Comparative Example 1 before ultraviolet exposure and FIG. 4 is an image of the artificial stone after exposure to ultraviolet rays for 1000 hours; and FIG. 5 is an image of artificial stone manufactured with the curable composition of Comparative Example 2 before ultraviolet exposure and FIG. 6 is an image of the artificial stone after exposure to ultraviolet rays for 1000 hours.

1. Artificial stone which is a cured product of a curable composition comprising: a polyol component; an isocyanate component comprising a bifunctional non-aromatic isocyanate compound and a multifunctional non-aromatic isocyanate compound having trifunctionality or more; and a filler.

2. The artificial stone according to claim 1, wherein the polyol component comprises 80 mol % or more of a polyol having a molecular weight of 500 g/mol or less.

3. The artificial stone according to claim 1, wherein the polyol component comprises 80 mol % or more of a non-aromatic polyol.

4. The artificial stone according to claim 3, wherein the non-aromatic polyol is a non-aromatic acyclic polyol.

5. The artificial stone according to claim 1, wherein the polyol component comprises a bifunctional polyol and a multifunctional polyol having trifunctionality or more.

6. The artificial stone according to claim 5, wherein the polyol component comprises 25 to 55 mol % of the bifunctional polyol.

7. The artificial stone according to claim 5, wherein the ratio (P2/PM) of the mole number (P2) of the bifunctional polyol to the mole number (PM) of the multifunctional polyol in the curable composition is in a range of 0.2 to 1.5.

8. The artificial stone according to claim 1, wherein the isocyanate component comprises 80 mol % or more of an isocyanate compound having a molecular weight of 1,000 g/mol or less.

9. The artificial stone according to claim 1, wherein the isocyanate component comprises 80 mol % or more of a non-aromatic isocyanate compound.

10. The artificial stone according to claim 1, wherein the bifunctional non-aromatic polyol is represented by the following formula 1: 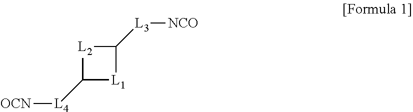
wherein, L₁ to L₄ are each independently a single bond or a linear or branched alkylene group having 1 to 20 carbon atoms.

11. The artificial stone according to claim 1, wherein the isocyanate component comprises 55 to 90 mol % of the bifunctional non-aromatic isocyanate compound.

12. The artificial stone according to claim 1, wherein the ratio (N2/NM) of the mole number (N2) of the bifunctional non-aromatic isocyanate compound to the mole number (NM) of the multifunctional non-aromatic isocyanate compound in the curable composition is in a range of 1.5 to 5.

13. The artificial stone according to claim 1, wherein in the curable composition, the ratio (P/N) of the mole number (P) of the polyol compound in the polyol component to the mole number (N) of the isocyanate compound in the isocyanate component is in a range of 0.4 to 1.5.

14. The artificial stone according to claim 1, wherein in the curable composition, the ratio (OH/NCO) of the mole number (OH) of the total hydroxyl groups in the polyol component to the mole number (NCO) of the total isocyanate groups in the isocyanate component is in a range of 0.8 to 1.2.

15. The artificial stone according to claim 1, wherein the filler is a quartz-based filler.

16. The artificial stone according to claim 1, wherein the curable composition comprises the filler in a ratio of 70 to 95 wt %.

17. The artificial stone according to claim 1, wherein the total weight part of the polyol component and the isocyanate component in the curable composition is in a range of 5 to 30 parts by weight relative to 100 parts by weight of the filler.

18. The artificial stone according to claim 1, wherein Ab* in the following equation 4 is in a range of −1.5 to 3:
Δb*=ba*−bi* [Equation 4]
wherein, ba* is the b* value of the artificial stone in the CIE Lab color coordinates immediately after being exposed to ultraviolet rays for 1000 hours, and bi* is the b* value of the artificial stone in the CIE Lab color coordinates immediately before exposure to the ultraviolet rays for 1000 hours.

19. The artificial stone according to claim 1, wherein the absolute value of the change amount ΔE of the color change index before and after exposure to ultraviolet rays for 1000 hours is 3 or less.

20. Artificial stone which is a cured product of a curable composition comprising:
a polyol component;
an isocyanate component comprising a bifunctional non-aromatic isocyanate compound and a multifunctional non-aromatic isocyanate compound having trifunctionality or more; and
a filler.
